(19) United States
(12) Patent Application Publication
(10) Pub. No.: US 2007/0086082 A1
(43) Pub. Date: Apr. 19, 2007

(54) Semiconductor optical device having a clamped carrier density

(76) Inventor: Beatrice Dagens, Antony (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 11/546,564

(22) Filed: Oct. 12, 2006

(30) Foreign Application Priority Data
Oct. 14, 2005 (FR) 05 10512

(51) Int. Cl. H01S 3/00

(52) U.S. Cl. 359/344

(57) ABSTRACT

The field of the invention is that of semiconductor devices used for the amplification or for the phase modulation of optical signals. These devices are known by the generic names SOA (semiconductor optical amplifier) and DPSK (differential phase shift keying) modulators. The main drawbacks of this type of device are that it is, on the one hand, difficult to obtain a constant gain, and, on the other hand, it is difficult for the optical signal to be independently amplitude-modulated and phase-modulated. The device according to the invention does not have these drawbacks. It relies essentially on three principles: the active zone of the device has a quantum dot structure, the atoms of said structure possessing a first energy transition state called the ground state and a second energy transition state called the excited state; the active zone is placed in a structured resonant cavity in order to resonate at a first wavelength corresponding to the ground state; and the current flowing through the active zone is greater than the saturation current of the ground state so as to allow oscillation at a second wavelength corresponding to the excited state.

### RELATED APPLICATION

The present application is based on, and claims priority from France Application Number 05 10512, filed Oct. 14, 2005, the disclosure of which is hereby incorporated by reference herein in its entirety.

### BACKGROUND OF THE INVENTION

1. Field of the Invention

The field of the invention is that of semiconductor devices used for the amplification or for the phase modulation of optical signals. The devices used for amplification are known by the generic name SOA (semiconductor optical amplifier).

2. Description of the Prior Art

Current semiconductor devices used for the amplification or the modulation of optical signals have several drawbacks.

Firstly, the variations in optical gain of the active medium are intrinsically linked to the variations in its optical index, the gain variations resulting in amplitude variations of the optical signals, and the optical index variations resulting in phase variations. Under these conditions, it is impossible to obtain a signal that is independently amplitude-modulated or phase-modulated. This phenomenon may appreciably degrade the performance of an optical modulator of the DPSK or DQPSK type.

Secondly, optical amplification devices have a major drawback. It is difficult to maintain a constant gain when the power of the optical signal becomes too high. FIGS. 1, 2 and 3 illustrate this principle. FIG. 1 shows the diagram of an amplifier having an active zone 1 through which the optical signal S to be amplified passes, said signal being shown symbolically by a striped straight arrow. Conventionally, this active zone 1 lies between two semiconductor layers 2 and 3, n-doped and p-doped respectively. FIG. 2 shows the variation in the amplification gain G of this amplifier as a function of the wavelength λ. The gain passes through a maximum for a certain wavelength and a certain current. FIG. 3 shows the variation in the gain G as a function of the initial optical power PIN of the optical signal incident on the amplifier. Above a certain optical power, called the saturation power P_{SAT}, the gain rapidly decreases. In general, P_{SAT} is the power corresponding to a gain equal to the maximum gain G_{MAX} reduced by 3 dB.

To alleviate this drawback, clamped-gain semiconductor optical amplifiers (CG-SOAs) are used. FIGS. 4, 5, 6 and 7 illustrate this principle. FIG. 4 shows the diagram of a CG-SOA amplifier. Conventionally, it comprises an active zone 1 lying between two semiconductor layers 2 and 3. The outermost parts of the structure undergo an optical treatment 4, which makes them reflective at a given wavelength λ_{L}, this treatment being shown symbolically by two horizontal bars in FIG. 4. This treatment is generally a Bragg grating. The structure thus forms an optical cavity in which optical radiation is capable of lasing. When the intensity of the current flowing through the active zone is sufficient, laser radiation is produced at the wavelength λ_{L}. The laser radiation L circulating inside the cavity is shown symbolically by an arrow in the form of a closed arc placed above the structure. In this case, for a given input power, the output power POUT as a function of the wavelength λ has the form shown in FIG. 5. It possesses a power peak at the laser wavelength λ_{L}. Signals having wavelengths close to this wavelength λ_{L} may be difficult to amplify. It is estimated that the total width of this blind zone centred on the laser wavelength λ_{L} is about 10 nanometres.

By adjusting the optical treatment and the geometrical parameters of the cavity, it is easy to position the wavelength λ_{L} so that it lies outside the maximum gain zone centred on the wavelength λ_{MAX}. It is therefore known that, inside the laser cavity, whatever the power emitted by the laser, the gain of the amplifying medium balances the losses due to the cavity. Thus, the number of charge carriers remains constant. Consequently, to a first approximation and as indicated in FIG. 6, an almost constant gain G is maintained for any optical signal having an initial optical power P_{IN} passing through the amplifying medium.

However, devices of the CG-SOA type still have certain drawbacks. Specifically, as shown in FIG. 7, as soon as the current exceeds a threshold current I^{L}, the output power of the laser P_{L} increases with the intensity of the current I passing through the active zone of the amplifier. Consequently, the laser power is not constant. Now, it has been demonstrated that the gain depends to a second order on the laser power. Specifically, the gain is expressed by the equation:

$$G = \frac{{G}_{0}}{1 + ɛ \cdot {P}_{LASER}}$$

where G₀ is a first constant and ε is a second constant, called the gain compression factor.

It has also been demonstrated that, if several optical channels modulated at different wavelengths are amplified simultaneously, an interference or crosstalk phenomenon may occur between channels. However, this phenomenon introduces quite weak perturbations.

### SUMMARY OF THE INVENTION

All these drawbacks are essentially due to the fact that the laser power remains dependent on the intensity of the current injected into the active zone. The object of the invention is to produce a structure in which, above a certain current threshold, the power of the output laser becomes substantially constant. Thus, most of the above difficulties are overcome.

More precisely, the subject of the invention is a semiconductor optical device controlled by a current generator, said device comprising at least one active zone having a quantum dot structure, the atoms of said structure possessing a first energy transition state called the ground state and a second energy transition state called the excited state, characterized in that the active zone is placed in a structured resonant cavity in order to resonate at a first wavelength corresponding to the ground state, the current generator delivering a current greater than the saturation current of the ground state.

Advantageously, the optical cavity may be of the DFB (distributed feedback) type or DBR (distributed Bragg reflector) type.

Advantageously, the device may be of the semiconductor optical amplifier type intended to amplify an optical signal of variable amplitude having a wavelength greater than the first wavelength, the current delivered by the current generator being substantially constant.

Advantageously, the device may also be of the phase modulator type, intended to phase-modulate an optical signal of constant amplitude having a wavelength greater than the first wavelength, the current delivered by the current generator being amplitude-modulated between a minimum value and a maximum value, the minimum value being greater than the saturation current of the ground state.

Advantageously, the quantum dot structure is produced on InGaAsP layers, the quantum dots being made of InAs or InAs/InP or InAs/AsGa.

### BRIEF DESCRIPTION OF THE DRAWINGS

The invention will be more clearly understood and other advantages will become apparent on reading the following description given by way of non-limiting example and using the appended figures wherein:

FIG. 1 shows the diagram of an SOA amplifier according to the prior art;

FIG. 2 shows the gain curve as a function of the wavelength of said SOA amplifier;

FIG. 3 shows the gain curve of the SOA as a function of the initial power of the incident signal;

FIG. 4 shows the diagram of a clamped-gain amplifier or CG-SOA;

FIG. 5 shows the output power as a function of the wavelength of said CG-SOA amplifier;

FIG. 6 shows the gain curve of the CG-SOA as the function of the initial power of the incident signal;

FIG. 7 shows the output power of the laser of the CG-SOA as a function of the current injected into the active zone;

FIG. 8 shows the energy transition levels in a quantum dot structure;

FIG. 9 shows the output power of the laser of the CG-SOA as a function of the current injected into the active zone;

FIG. 10 shows the diagram of a CG-SOA according to the invention;

FIG. 11 shows the gain curve as a function of the wavelength of a CG-SOA according to the invention;

FIG. 12 shows the gain curve of the CG-SOA according to the invention as a function of the initial power of the incident signal;

FIG. 13 shows the variation of the injected current as a function of time in a DPSK-type optical modulator according to the invention;

FIG. 14 shows the amplitude variations of an optical signal passing through said modulator; and

FIG. 15 shows the phase variations of said optical signal.

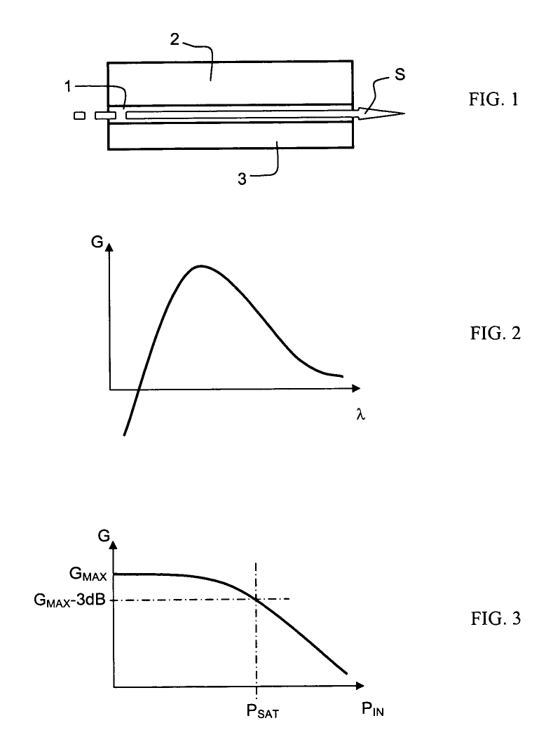

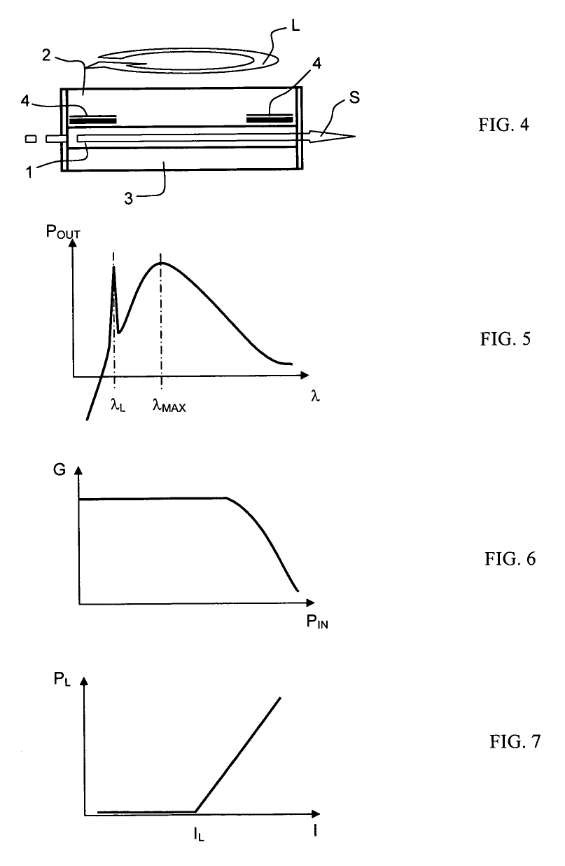

### MORE DETAILED DESCRIPTION

The quantum dots are microstructures that contain a small quantity of charge carriers, free electrons or holes. They are fabricated in semiconductor-type materials and have dimensions between a few nanometres and a few tens of nanometres in the three dimensions of space. The size and shape of these structures, and therefore the number of holes that they contain, may thus be precisely controlled. As in an atom, the energy levels in a quantum dot are quantized, which makes these structures particularly advantageous for a large number of physical applications.

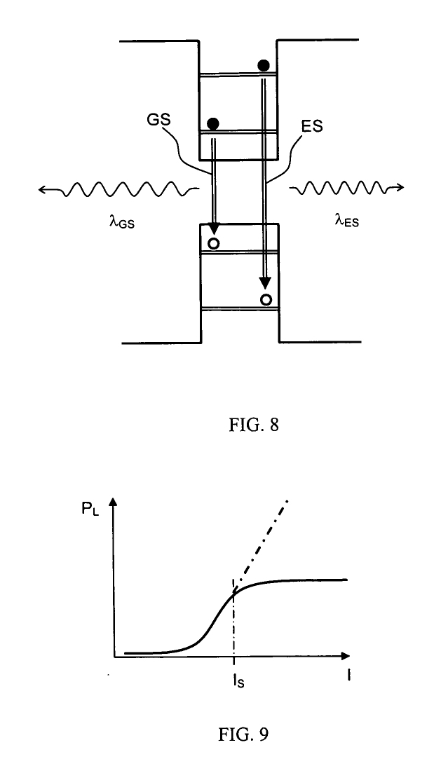

As shown in FIG. 8, only two possible energy transition states may exist in a quantum dot structure, called the ground state (GS) and the excited state (ES), the ground state corresponding to the lowest energy level. These two transition states correspond to the two vertical arrows shown in FIG. 8. Corresponding to these two transition states are two emission wavelengths, denoted by λ_{ES} and λ_{GS}. As already mentioned, the number of carriers corresponding to a possible transition is finite and can be easily reached. When the energy levels corresponding to the ground state are filled, then the possible transitions can correspond only to the higher energy level, i.e. the excited state.

Thus, as illustrated in FIG. 9, in a structure of the CG-SOA type, in which the active zone is based on quantum wells, when this structure is subjected to a current I of charge carriers, the laser emits a power PL firstly at the wavelength corresponding to the ground state, namely the wavelength λ_{GS}, as shown by the solid curve in FIG. 9. The power PL emitted by the laser firstly varies linearly up to a certain value of the current Is, called the saturation current. Above this value, since the energy levels corresponding to the ground state are filled, the power PL emitted by the laser remains constant at this wavelength λ_{GS}. The structure can then emit at the wavelength λ_{ES}, corresponding to the excited transition state. At the wavelength λ_{ES}, the structure becomes transparent. This means that, when an optical signal at this wavelength λ_{ES} passes through the structure, it undergoes a gain equal to or greater than the absorption losses. If the structure is placed in a cavity and if the gain is sufficient also to compensate for the optical losses of the cavity, then the structure can emit laser radiation at the wavelength λ_{ES}. The power emitted at this wavelength is plotted as the dotted line in FIG. 9.

Consequently, to obtain a constant gain in a semiconductor optical device controlled by a current generator possessing an active zone, it is necessary that three conditions be met:
the active zone must include a quantum dot structure, the atoms of said structure possessing a first energy transition state called the ground state and a second energy transition state called the excited state;
the active zone must be placed in a structured resonant cavity in order to resonate at a first wavelength corresponding to the ground state; and
the current generator must deliver a current greater than the saturation current of the ground state in order to clamp the output power of the ground state and ensure transparency at a second wavelength corresponding to the excited state.

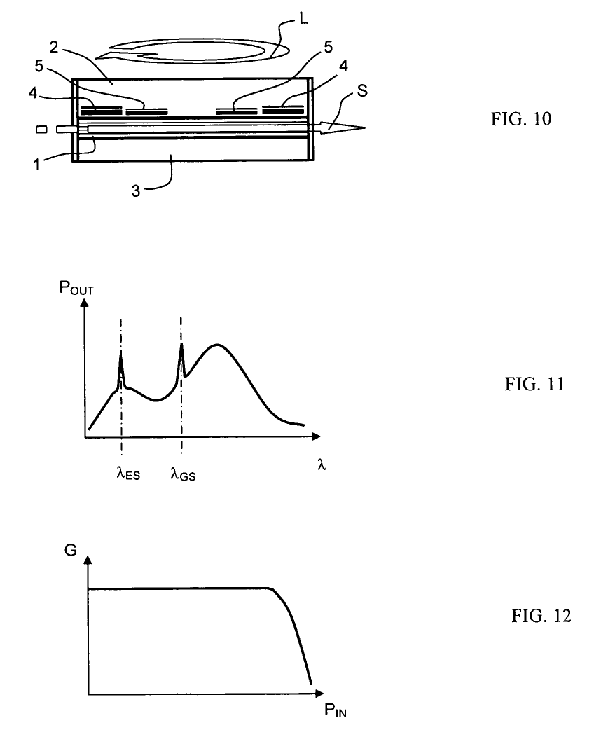

Such a structure is shown in FIG. 10. It essentially comprises an active zone 1 lying between two doped semiconductor layers 2 and 3. The active zone 1 comprises at least one quantum dot structure. The outermost parts of the structure undergo an optical treatment 4, which makes them reflective at the wavelength λ_{GS}, this treatment being shown symbolically by two horizontal bars in FIG. 10. The structure thus forms an optical cavity in which optical radiation is able to lase at this wavelength. The cavity may also include a second treatment 5 reflective at the wavelength λ_{ES} SO that optical radiation can also oscillate at this wavelength λ_{ES}. The laser radiation L circulating inside the cavity is shown symbolically by an arrow in the form of a closed arc.

Under these conditions, for a given input power, the output power POUT as a function of the wavelength λ has the form shown in FIG. 11. It possesses two gain peaks at the laser wavelengths λ_{GS} and λ_{ES}. The wavelength of the optical signal λ_{S} passing through the structure must then be greater than λ_{GS}, as indicated in FIG. 11.

As indicated in FIG. 12, a constant gain is then maintained for any optical signal having an initial power P_{IN} passing through the amplifying medium on the condition that its wavelength be greater than λ_{GS}.

This type of structure has two main applications.

In a first application, the device is of the semiconductor optical amplifier type. It is intended to amplify an optical signal of variable amplitude having a wavelength greater than the first wavelength λ_{GS}. The current delivered by the current generator must deliver a current greater than the saturation current of the ground state and be substantially constant. A constant amplification gain is thus obtained.

In a second application, the device is of the phase modulator type, intended to phase-modulate an optical signal of constant amplitude having a wavelength greater than the first wavelength. The phase modulators may be of the PSK (phase shift keying) type. Modulators of the PSK type operate by phase shifting. Thus, logic level 0 is coded by a reference phase equal to 0° and logic level 1 is coded by a reference phase equal to 180°. Variants of the DPSK (differential phase shift keying) or DQPSK (differential quadrature phase shift keying) type exist.

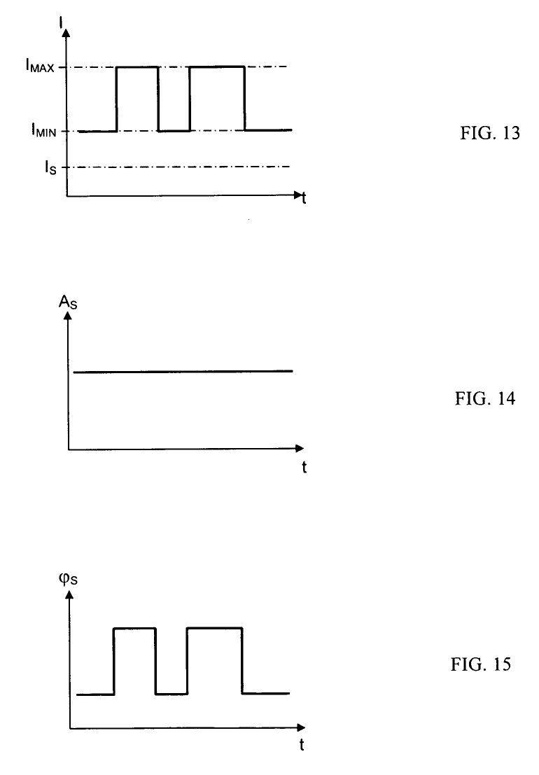

As illustrated in FIG. 13, the current I delivered by the current generator is then amplitude-modulated as a function of time t between a minimum value I_{MIN} and a maximum value I_{MAX}, the minimum value being greater than the saturation current Is of the ground state. Under these conditions, the amplitude gain of the modulator remains constant despite the amplitude modulations of the current. The amplitude As of an output signal remains constant, as illustrated in FIG. 14. On the other hand, the amplitude modulations of the current result in a modulation of the number of carriers belonging to the energy transition state called the excited state, this modulation causing a modulation of the optical index of the active zone. Furthermore, this index modulation results in a modulation of the phase (φ_{S} of the output optical signal, as illustrated in FIG. 15. Thus, it is possible to generate optical signals possessing pure phase modulations, without parasitic amplitude modulations.

The production of quantum dot structures poses no particular problem. The active layer having the quantum dots may be produced on InGaAsP layers. The quantum dots may be made of InAs or InAs/InP or InAs/AsGa. Of course, it is necessary to respect the necessary compatibilities between the materials of the support layers and those of the actual quantum dots.

What is claimed is:

1. A semiconductor optical amplifier intended to amplify an optical signal of variable amplitude, said amplifier being controlled by a current generator and comprising at least one active zone having a quantum dot structure, the atoms of said structure possessing a first energy transition state called the ground state and a second energy transition state called the excited state, wherein the active zone is placed in a structured resonant cavity in order to resonate at a first wavelength corresponding to the ground state, the current generator delivering a current greater than the saturation current Iₛ of the ground state and substantially constant, the optical signal having a wavelength greater than the first wavelength.

2. A semiconductor phase modulator intended to phase-modulate an optical signal of constant amplitude, said modulator being controlled by a current generator and comprising at least one active zone having a quantum dot structure, the atoms of said structure possessing a first energy transition state called the ground state and a second energy transition state called the excited state, wherein the active zone is placed in a structured resonant cavity in order to resonate at a first wavelength corresponding to the ground state, the current delivered by the current generator being amplitude-modulated between a minimum value and a maximum value, the minimum value being greater than the saturation current of the ground state, the optical signal having a wavelength greater than the first wavelength.

3. The semiconductor optical amplifier according to claim 1, wherein the cavity is of the DFB type or DBR type.

4. The semiconductor phase modulator according to claim 2, wherein the cavity is of the DFB type or DBR type.

5. The semiconductor optical amplifier according to claim 1, wherein the quantum dot structure is produced on InGaAsP layers, the quantum dots being made of InAs or InAs/InP or InAs/AsGa.

6. The semiconductor phase modulator according to claim 2, wherein the quantum dot structure is produced on InGaAsP layers, the quantum dots being made of InAs or InAs/InP or InAs/AsGa.
